(19) United States
(12) Patent Application Publication
(10) Pub. No.: US 2025/0385492 A1
(43) Pub. Date: Dec. 18, 2025

(54) PEDESTAL CAP ASSEMBLY AND METHOD

(71) Applicants: Christopher Corbett, Valdosta, GA (US); Roger Blaine Trivette, Boiling Springs, SC (US)

(72) Inventors: Christopher Corbett, Valdosta, GA (US); Roger Blaine Trivette, Boiling Springs, SC (US)

(21) Appl. No.: 18/746,240

(22) Filed: Jun. 18, 2024

(51) Int. Cl. H02B 1/50; H02B 1/46

(52) U.S. Cl. CPC H02B 1/50; H02B 1/46

(57) ABSTRACT

A raised pedestal cap for attachment to a utility box includes a main body member and a circular base, wherein the raised pedestal cap defines a space therein that is positioned above the utility box. The raised pedestal cap is removably securable to an opening in the top of a subterranean utility box so that the raised pedestal cap extends above ground level to increase visibility, so that the utility box is easy to visually locate. The raised pedestal cap is preferably integrally formed into a monolithic piece, and may include additional features, including lights, a motion sensor, a solar cell, and a variety of temporary attachment means for removable attachment to an opening on the upper surface of a utility box.

### BACKGROUND OF THE INVENTION

There are many types of utility boxes and similar structures that are used in connection with infrastructure to support residential and commercial buildings and developments in the modern era. Oftentimes, these utility boxes are completely or partially buried, and include a cap or lid that may be removed to gain access to the components housed therein. For example, utility boxes are used to house water meters for measuring the amount of water that flows into a home or other building, for purposes of providing invoices to the owner thereof. Other types of sub-terranean utility boxes are used for other purposes, such as housings for electrical or plumbing components, irrigation systems, internet junctures, fiber optic communications, and the like.

One issue associated with many of these types of utility boxes is that the lids or caps are positioned roughly at ground level in a horizontal orientation, and over time, may become overgrown with weeds, grass or other brush, or may simply become buried under layers of dirt, particularly in areas with high erosion problems. Additionally, in an emergency situation, and particularly at night, it may be difficult to find the utility box when time is of the essence. For instance, if a pipe bursts in a residential home at night due to cold weather, it may be imperative to find the main water valve, which is often housed in an underground utility box, so that a user may shut off the water in order to mitigate water damage within their home. Furthermore, the caps or lids on currently existing utility boxes may also become damaged by lawn maintenance machinery, such as mowers or other heavy equipment used for such purposes.

Thus, it would be desirable to provide a raised pedestal cap for a subterranean utility box that may be easily spotted and located without having to spend an inordinate amount of time searching for it. Moreover, such a device would be useful not only for the property owner, but also for technicians and other employees of the utility companies who routinely go to these homes and businesses to perform maintenance, check the meters, or perform other such tasks on site.

There are raised pedestals that are used in connection with utilities, although most of the known pedestals do not serve as a cap or lid to a subterranean utility box. Rather, these known pedestals actually serve, in most cases, as the utility box itself, so that the utility components (electrical, plumbing, fiber optic, etc.) are actually housed within the pedestal itself. In order to access these internal components, the currently used pedestals typically include a door, hatch, or a way to simply lift the pedestal away from the internally housed components.

The following references disclose various types of known pedestals for housing internal utility components, and each of the documents referenced below are hereby incorporated herein by reference, in their entireties:

U.S. Pat. No. 4,365,108 Secondary Power Pedestal for Electrical Equipment

A tubular housing and cover therefor, forming a secondary power pedestal, have a tapered construction and are arranged to nest together in shipment, storage and handling. The lower end of the housing is open and has substantially straight walls at its lower end to provide such nesting with the cover. The opposite sides of the housing adjacent the bottom are slotted and are arranged to receive a pair of side strips capable of being held in the slots by a pair of connecting strips combining with the side strips to form a ground anchor flange. The connecting strips are of a structure facilitating their use as a ground anchor stake in the event that a ground anchor stake is to be used rather than a ground anchor flange.

U.S. Pat. No. 4,892,978 Self-Supporting Pedestal

The pedestal is particularly suitable for housing cable television signal distribution outdoor equipment. It has a self-supporting base having a truncated pyramidal shape and a horizontal lower flange, which can be installed firmly and securely on the ground easily and quickly without the use of additional anchoring devices. The divergent base also provides inherent additional space for storing extra cable for future re-coring and changing equipment, and a plurality of the base units as well as a plurality of top cover units may be stacked together for maximum utilization of the shipping and storage space.

U.S. Pat. No. 6,455,772 Data Transmission Pedestal Extension

An extension housing for a data transmission pedestal is disclosed. The extension has an upper portion essentially identical to the upper portion of a base of a pedestal and a lower portion essentially identical to the lower portion of a cover section of a pedestal. The extension is simple and inexpensive and can be used singly or in multiple quantities depending upon the pedestal height to be achieved. The use of extensions alleviates inventory of different size pedestals and allows quick and easy height adjustments in the field.

U.S. Pat. No. 7,038,127 Universal Mounting Arrangement for Components of an Electronic Enclosure

A pedestal enclosure for electronic components is provided. The pedestal enclosure includes a base section and a cover engageable with the base section so as to define an interior space. The bracket system has at least two side rails. The pedestal enclosure further includes a mounting arrangement for releasably mounting a bracket system to the base section. The mounting arrangement includes a channel section at a lower end of each of the side rails of the bracket system and a mounting part supported on the base section. Each of the mounting parts is configured and arranged to be received in and engage a respective one of the channel sections. The mounting arrangement includes a manually releasable locking mechanism.

U.S. Pat. No. 7,696,431 Distribution Terminal Pedestal Spade for Hardware Free Assembly

A spade or stake for hardware free mounting to a telecommunications data distribution terminal pedestal is disclosed. The spade may include one or more connectors of various types for engaging the pedestal to thereby couple the spade to the pedestal without hardware, and thus without tools. The pedestal may also include one or more connectors for mating with corresponding connectors on the stake.

U.S. Pat. No. 9,518,369 Equipment Housing

A housing for covering equipment located underground may include a body having a top, a bottom and a pipe aperture. The body may include at least two knockouts formed in the pipe aperture. The knockouts may be configured to be individually and selectively removed from the pipe aperture to adjust a height of the pipe aperture relative to the bottom of the body. In addition, a lid may be configured to be mounted to the body, and the lid is movable between an unlocked position and a locked position.

### U.S. Patent Publication No. 20050103780 Pedestal Closure Assembly

An improved outdoor telecommunication pedestal having a dome and a two part base. The base includes inner and outer horizontal and vertical ribs to greatly enhance in-ground stability. The dome also includes vertical ribs to engage slots in the base to give good security. Security is further enhanced by a spring loaded lock mechanism that requires only a quarter turn to unlock. A cam follower wall is provided on a slider of the lock to allow a snap attachment of the dome and the base once full engagement is reached.

### U.S. Patent Publication No. 20050215090 Electronic Enclosure

A pedestal enclosure for electronic components is provided. The pedestal enclosure includes a base section and a cover engageable with the base section so as to define an interior space. The base section has a generally rectangular configuration and having a plurality of longitudinally extending channels formed therein such that the base section is substantially self-supporting in the ground. The cover has a generally cylindrical configuration and is engageable with a cylindrical neck on the base section so as to define an interior space. A bracket system is supported on the base section and arranged in the interior space. The bracket system includes a pair of legs. The base section comprises front and rear housing sections that can be selectively assembled together and split apart without removal of the bracket system. A lock mechanism is arranged near the top or near the bottom of the cover. A first lock receptacle is arranged on the base section for receiving the lock mechanism when the cover is engaged with the base section and the lock mechanism is arranged near the bottom of the cover and a second lock receptacle is arranged on the bracket system for receiving the lock mechanism when the cover is engaged with the base section and the lock mechanism is arranged near the top of the cover. A splice bar is pivotably supported between the legs of the bracket system for movement between an locked position wherein a hook at each end of the splice bar engages a respective one of the legs of the bracket system and an unlocked position wherein the splice bar is disengaged from the legs of the bracket system.

### U.S. Patent Publication No. 20070183732 Fiber Optic Splice Enclosure

A fiber optic splice enclosure for housing an interconnection contained in a splice tray between at least one optical fiber of a feeder cable and at least one optical fiber of a drop cable is provided. The optical fiber of the feeder cable is at least partially contained in a feeder cable buffer or transportation tube. The fiber optic splice enclosure includes a support frame arranged in the enclosure. The support frame includes a central office side and a drop side. A basket is arranged on the support frame for storing slack of a spliced buffer tube transitioning to the splice tray. The spliced storage arrangement is sized so as to be able to store slack of the spliced feeder cable buffer tube while maintaining a predetermined tube bend radius. A splice tray mounting arrangement is arranged on the drop side of the support frame for supporting the splice tray.

### U.S. Patent Publication No. 20100079041 Outdoor Telecommunications Equipment Enclosures Having Slide Lock Assemblies

An outdoor telecommunications equipment enclosure includes a dome, a base for receiving the dome, and a slide lock assembly for coupling the dome to the base. The slide lock assembly includes a housing coupled to one of the dome and the base and defining a channel and a slider positioned within the channel. The slider is moveable between a retracted position and an extended position for engaging the other one of the dome and the base. In one example embodiment, one of the slider and the housing includes multiple protrusions in contact with the other one of the slider and the housing. The protrusions inhibit surface contact between the slider and the housing. In another example embodiment, the slide lock assembly includes a gasket, seal and/or plug to inhibit ingress of debris into the slide lock assembly. In yet another example embodiment, the slide lock assembly includes a rotator having an actuator head accessible to a user such that when the rotator is rotated in a first direction via the actuator head, the rotator moves the slider into the extended position.

### U.S. Patent Publication No. 20190123533 Pedestal Enclosure for Utility Components

A pedestal housing for utility connections includes a lower section having a plurality of walls, an upper surface, and a bottom opening. A first rim is formed on the lower section positioned below the upper surface. A second rim is formed on the lower section positioned below the first rim. An upper section includes a plurality of walls and a top. The upper section is releasably connected to the lower section to form a housing for receiving one or more utility components. The upper section is configured to mate with one of the first rim or the second rim.

### SUMMARY OF THE INVENTION

The present invention, in one embodiment, includes a raised pedestal cap for a utility box, wherein the raised pedestal cap includes a circular base portion having at least two outwardly projecting protrusions. The pedestal cap is designed to be removably attached to a circular opening located on the upper surface of a utility box that is used to house any type of utility components, such as electrical, plumbing, irrigation, communications, or the like. The circular opening on the top of the utility box preferably includes a circular rim having a pair of recessed spaces for receiving the outwardly projecting protrusions, so that the pedestal cap fits snugly into the opening of the utility box. Once the pedestal cap is in place on the utility box, the pedestal cap may be rotated slightly, so that the protrusions are misaligned with the recessed spaces of the utility box opening, which secures the pedestal cap in place. To remove the pedestal cap from the utility box, the pedestal cap may be rotated in the opposite direction until the protrusions of the pedestal cap are in alignment with the recessed spaces of the utility box opening, and the pedestal cap may be easily lifted away from the utility box to provide access to the components through the opening on the top side thereof.

Alternatively, the pedestal cap may include a threaded portion around the circular base, which screws into a threaded opening on the top portion of the utility box.

This arrangement, including the raised pedestal cap that extends upwardly above ground level, allows a property owner, utility employee, landscape professional or the like, to easily locate the utility box without having to spend time searching for it.

In some embodiments, lights may be provided, either on the inside of the pedestal cap (which illuminates the pedestal cap from the inside), or on the outside of the pedestal cap, to provide increased visibility at night or in dark places.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a perspective exploded view of one embodiment of a raised pedestal cap assembly, including the raised pedestal cap and a removable insert with a securing screw positioned above a subterranean utility box, wherein the raised pedestal cap includes a round base with a pair of outwardly extending protrusions that fits into the opening in the top of the utility box that includes a complementary round lip with recessed spaces for receiving the protrusions on the base of the raised pedestal cap;

FIG. 2 is a side view of one embodiment of a raised pedestal cap assembly, wherein the utility box is partially buried in the ground, and the raised pedestal cap is secured onto the opening of the utility box, thus providing an open space within the raised pedestal cap that is above ground level;

FIG. 3 is a perspective view of the embodiment of the raised pedestal cap as set forth in FIG. 1, wherein the insert is positioned within the complementary opening on the side of the main body member of the raised pedestal cap, and a screw extends downwardly through the insert;

FIG. 4 is a perspective view of another raised pedestal cap, wherein this embodiment is formed as a single-piece, monolithic construction;

FIG. 5 is a perspective exploded view of the raised pedestal cap assembly as set forth in FIG. 1, including the raised pedestal cap and a removable insert with a securing screw;

FIG. 6 is a side cutaway view of one embodiment of a raised pedestal cap, further illustrating a solar cell positioned on the top surface of the raised pedestal cap, and further showing wires connecting the solar cell to a battery pack, and an LED light strip, wherein the battery pack and LED light strip and associated wiring are all disposed within an inner portion of the raised pedestal cap; and

FIG. 7 is a perspective, cutaway view of one embodiment of a raised pedestal cap assembly, further illustrating a solar cell positioned on the top surface of the raised pedestal cap, wherein the solar cell is wired to a battery pack that is positioned within the open space inside the raised pedestal cap, and further illustrating a strip of LED lights that are disposed about an outer perimeter of the upper portion of the raised pedestal cap, wherein the LED light strip is powered by the battery pack, which is charged by the solar cell.

### DETAILED DESCRIPTION OF THE INVENTION

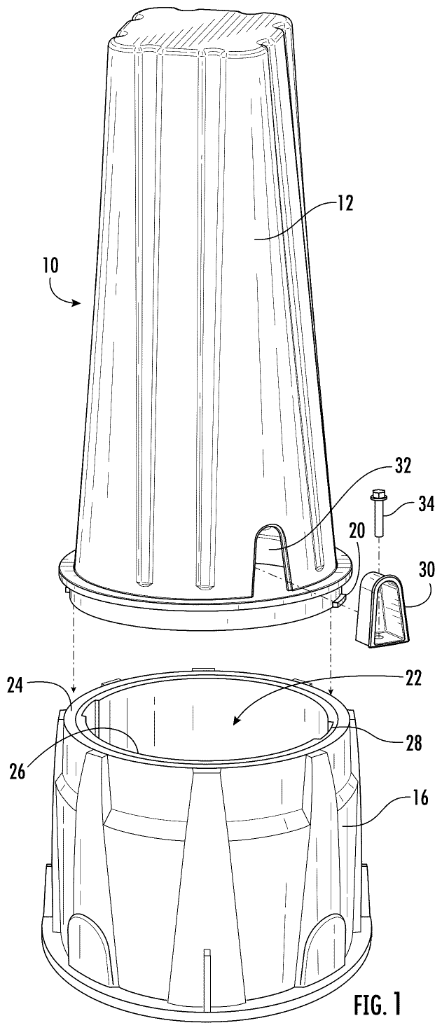

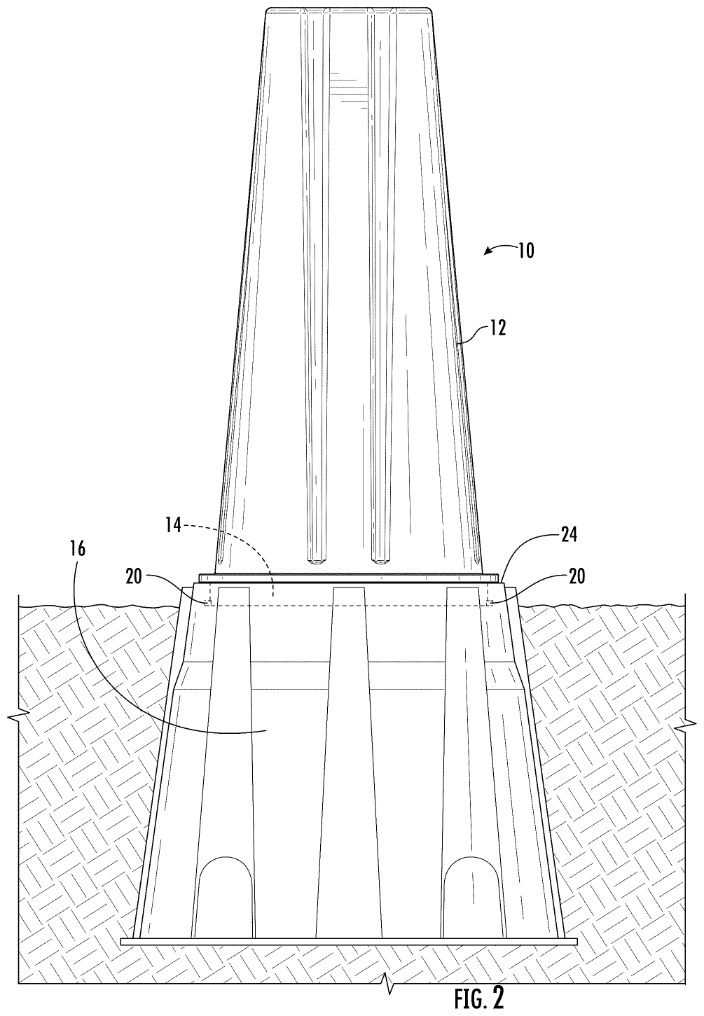

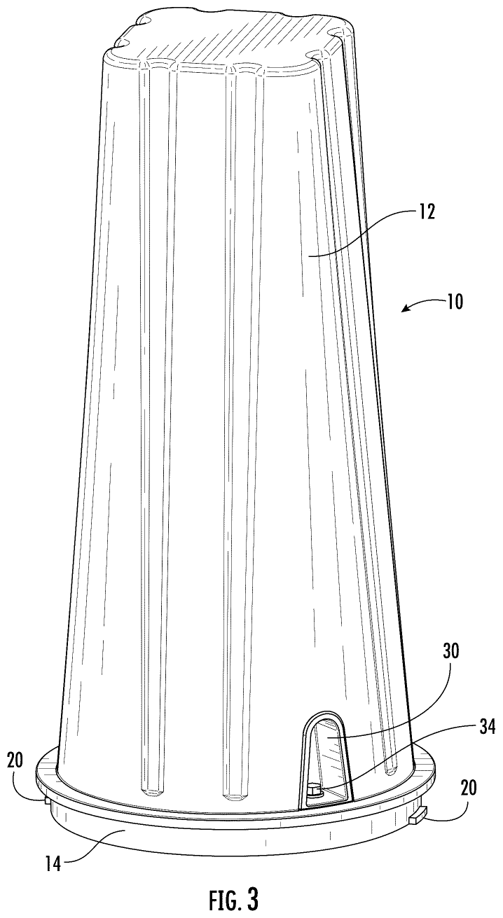

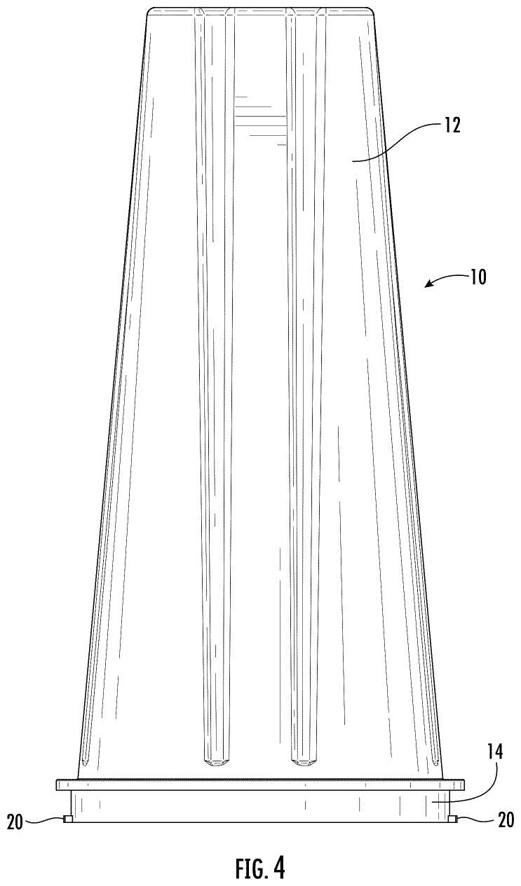

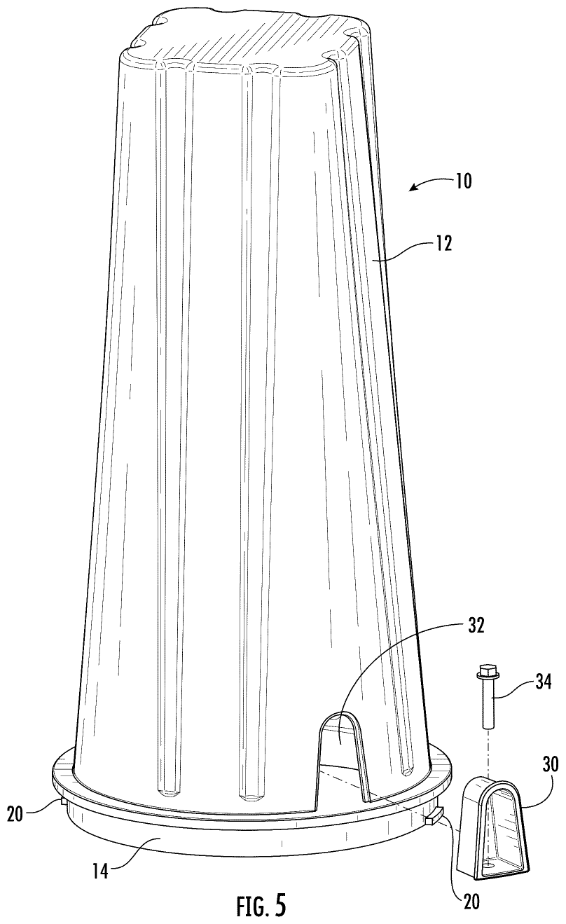

As shown in FIGS. 1-7, the present invention includes, in one embodiment, a raised pedestal cap 10 comprising a four-sided main body member 12 having a circular shaped base 14 on a bottom portion thereof. The raised pedestal cap 10 defines an inner space therein that is positioned above ground-level, which may be used for various purposes, some of which are discussed hereinbelow. The pedestal cap 10 is removably attachable to a utility box 16 that may be used in connection with any type of utility components, including electrical, mechanical, plumbing, internet or other communications, irrigation systems, or the like. Typically, the utility boxes 16 are subterranean in nature, so that they are either buried or partially buried in the ground as support infrastructure for residential or commercial buildings or developments, as shown in FIG. 2. In a preferred embodiment, the main body member 12 is integrally formed as a single, monolithic piece, as shown in FIGS. 2 and 4, although it is contemplated that the main body member 12 may be formed from separate pieces that are assembled to form the main body member.

The circular base portion 14 preferably includes at least two outwardly projecting protrusions 20 that are positioned on opposed sides of the circular base portion 14. It is contemplated that additional protrusions 20 may be positioned intermittently about the circular base portion 14, as desired. The pedestal cap 10 is designed to be removably attached to a circular opening 22 located on the upper surface 24 of a utility box 16 that is used to house any type of utility components, such as electrical, plumbing, irrigation, communications, or the like. The circular opening 22 on the top surface 24 of the utility box 16 preferably includes a circular rim 26 having a pair of recessed spaces 28 for receiving the outwardly projecting protrusions 20, so that the pedestal cap 10 fits snugly into the opening 22 within the rim 26 of the utility box 16. Once the pedestal cap 10 is in place on the utility box 16, the pedestal cap 10 may be rotated slightly, so that the protrusions 20 are misaligned with the recessed spaces 28 of the utility box rim 26, which secures the pedestal cap 10 in place thereon. To remove the pedestal cap 10 from the utility box 16, the pedestal cap 10 may be rotated in the opposite direction until the protrusions 20 of the pedestal cap 10 are in alignment with the recessed spaces 28 of the utility box rim 26, and the pedestal cap 10 may be easily lifted away from the utility box 16 to provide access to the components housed therein through the opening 22 on the top surface 24 thereof.

Some embodiments may further include additional securing means to removably secure the pedestal cap 10 to the utility box 16. For example, a removable insert 30 may be removably positioned in a complementary shaped hole 32 that is formed in a side wall of the main body member 12, as shown in FIGS. 1, 3 and 5. The removable insert 30 may further define a hole in a bottom portion thereof, which may include threads for receiving a screw 34. In one embodiment, the screw 34 may simply tighten directly against an inner lip positioned about a lower perimeter of the utility box rim 26 surrounding the opening 22. Alternatively, a complementary hole may be defined within the inner lip of the rim 26, so that when the pedestal cap 10 is inserted into the circular opening 22 in the utility box 16 and is twisted into position to misalign the protrusions 20 from the recessed spaces 28, the screw 34 may be tightened to hold the raised pedestal cap 10 in place with respect to the utility box 16. Once the pedestal cap 10 is in this position, the screw 34 may be screwed into the hole in the insert 32, in order to removably secure the pedestal cap 10 in the secured position with respect to the utility box 16. To remove the pedestal cap 10 from the utility box 16 in this embodiment, the screw 34 is simply unscrewed from the hole 32 in the insert 30, allowing the pedestal cap 10 to freely twist until the protrusions 20 are aligned with the recessed spaces 28 so the pedestal cap 10 may be lifted vertically away from the utility box 16.

It should be understood that both holes (the hole 32 defined in the bottom portion of the insert and the complementary hole in the utility box 16) may be threaded, or the hole 32 defined by the insert 30 may be unthreaded while the hole in the lip of the utility box 16 is threaded. Of course, other means may be substituted for the screw 34, such as, for example, a locking pin with a spring-loaded pop-out button or any other suitable type of connection (including various types of snap-fit connections) to temporarily prevent or inhibit the pedestal from twisting with respect to the utility box for purposes of removal.

It is also contemplated that other means of attachment may be used to removably attach the pedestal cap 10 to the opening 22 on a utility box 16. For example, the pedestal cap 10 may include a threaded portion around the circular base 14, which screws into a threaded portion on the inside of the circular rim 26 of the utility box 10. Other removable attachment means may include latches, snap-fit mechanisms, or other common attachment means that allow the pedestal cap to be removably attached to the utility box.

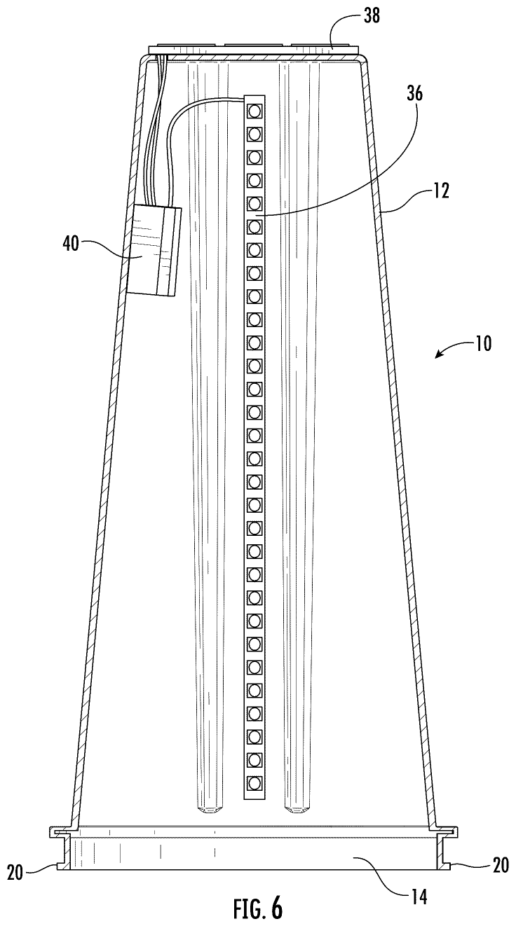

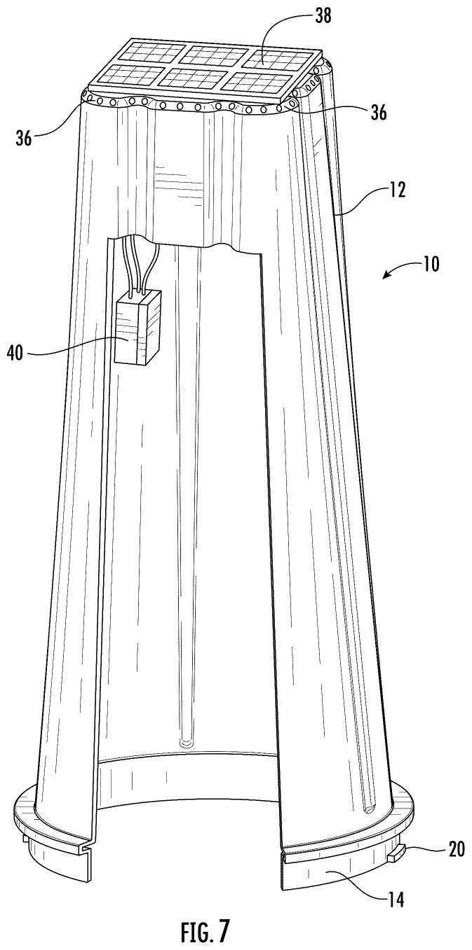

Some embodiments of the raised pedestal cap 10 may include lights 36 to illuminate the pedestal cap 10. For example, in one embodiment, lights 36 may be disposed inside of the pedestal cap 10 to allow the pedestal cap 10 to glow, so that light penetrates through the material of the pedestal cap 10, as shown in FIG. 6. Such lights may include one or more strands of LED lighting, one or more individual light bulbs, rope lighting, or the like. In another embodiment, lights 36 may be affixed to the outside portions of the main body member 12 in any desired manner, an example of which is shown in FIG. 7.

In one particularly preferred embodiment shown in FIGS. 6-7, a solar panel or solar cell 38 may be mounted on the top surface of the pedestal cap 10, or on one or more side surfaces thereof, which may be used to charge a battery or battery pack 40 that is positioned within the pedestal cap 10, in order to illuminate the lights 36. In this embodiment, the lighting system also preferably includes a photosensor to detect low light levels, so that the lights 36 are only turned on at night or in darkness, so that the lights 36 are shut off during daylight hours. It is also contemplated that a motion sensor may be attached to the pedestal cap 10 so that the motion sensor is operationally connected to the lighting system to illuminate the lights 36 when motion is detected. Additionally, it should be understood that the lights may be hardwired to an electrical source, plugged into an outlet, or powered in any other suitable manner.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A raised pedestal cap for attachment to a utility box, said raised pedestal cap comprising:
a main body member having a circular base, said main body member defining an enclosed space therein, and wherein said main body member is integrally formed in monolithic fashion;
attachment means for removably securing said raised pedestal cap to an opening on an upper portion of a utility box, thereby enclosing said opening in said utility box and providing an internal space within said raised pedestal cap above said utility box.

2. The raised pedestal cap set forth in claim 1, wherein said attachment means include a pair of protrusions projecting outwardly from said circular base.

3. The pedestal cap set forth in claim 1, further including a shaped insert, wherein said shaped insert is removably positioned within an opening in a side of said main body member, wherein said opening in said side of said main body member defines a complementary shape to said shaped insert.

4. The pedestal cap set forth in claim 3, wherein said shaped insert includes a hole defined in a bottom portion thereof for receiving a screw.

5. The pedestal cap set forth in claim 1, further including at least one light attached to said main body member.

6. The pedestal cap set forth in claim 5, further including a solar cell attached to an upper portion of said main body member for collecting solar radiation to convert into electricity, wherein said solar cell is operatively connected to a rechargeable battery, and wherein said rechargeable battery is operatively connected to said at least one light.

7. The pedestal cap set forth in claim 5, further including a motion sensor attached to said main body member, said motion sensor being operatively connected to said at least one light so that when said motion sensor detects motion, said motion sensor causes said at least one light to illuminate.

8. The pedestal cap set forth in claim 5, wherein said light is positioned within said internal space defined by said raised pedestal cap.

9. The pedestal cap set forth in claim 1, wherein said attachment means includes a threaded portion positioned on said circular base.

10. A method for providing a subterranean utility box, said method comprising the steps of:
providing a utility box having a circular opening on an upper side thereof;
providing a raised pedestal cap having an integrally formed main body member with a circular base member that fits into said circular opening of said utility box, wherein said raised pedestal cap defines an inner space above said utility box; and
removably attaching said raised pedestal cap to said utility box.

11. The method for providing a subterranean utility box set forth in claim 10, further comprising the step of:
installing said utility box in a ground surface so that said utility box is at least partially buried in said ground surface, and so that said internal space defined with said raised pedestal cap is above said ground surface.

12. The method for providing a subterranean utility box set forth in claim 10, further comprising the step of:
attaching at least one light to said raised pedestal cap.

13. The method for providing a subterranean utility box set forth in claim 12, further comprising the step of:
attaching a solar cell to an upper portion of said main body member for collecting solar radiation to convert into electricity, wherein said solar cell is operatively connected to a rechargeable battery, and wherein said rechargeable battery is operatively connected to said at least one light.

14. The method for providing a subterranean utility box set forth in claim 12, further comprising the step of:
providing a motion sensor that is operatively connected to said at least one light, so that when said motion sensor detects motion, said motion sensor causes said at least one light to illuminate.
